(19) United States
(12) Patent Application Publication
(10) Pub. No.: US 2007/0195535 A1
(43) Pub. Date: Aug. 23, 2007

(54) Reflector system for led illuminated display case

(75) Inventors: Paul J. Artwohl, Flossmoor, IL (US); Dennis Kato, Huntington Beach, CA (US); Matthew Rolek, Valencia, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Anthony, Inc., Sylmar, CA (US)

(21) Appl. No.: 11/361,179

(22) Filed: Feb. 23, 2006

(51) Int. Cl. F21V 7/00

(52) U.S. Cl. 362/341

(57) ABSTRACT

A lighting system for a commercial display case. The display case includes a plurality of mullions disposed in a vertical orientation between doors of the display case. A plurality of light emitting diodes are disposed in a linear array on each of the mullions. A reflector system is mounted proximate to the light emitting diodes. In one embodiment, the mullion cover and reflector system are formed as an integral assembly. In another embodiment, the mullion cover and reflector system are formed separately, and the mullion cover includes recesses or other mounting features, and the reflector system is coupled to the recesses in the mullion cover. The reflective system is preferably designed to have a series of reflector surfaces disposed about one or more of the light emitting diodes to optimize light dispersal.

### TECHNICAL FIELD

This disclosure relates generally to lighting systems, and more particularly to lighting systems using light emitting diodes (“LED's”).

### BACKGROUND

Commercial retailers frequently display their wares on shelves in display cases. Often, these display cases are fitted with light sources that attempt to direct light toward the display case shelves, thereby illuminating the products being offered for sale. Frequently, the light sources are fluorescent lamps, which are more energy efficient that incandescent lamps. However, fluorescent lamps have numerous drawbacks, particularly in an environment such as a refrigerated display case, which make it desirable to seek alternative lighting solutions.

For example, the gases held within the fluorescent tube must be heated in order to fire and remain lit, and the cold environment can lower the temperature of the gases and make it difficult to fire them. Also, the filaments in fluorescent tubes are easily burnt or broken. Further, the thin glass of the fluorescent tube is highly susceptible to breakage. In addition, the useful life of a typical fluorescent tube is between 1500 to 5000 hours, and thus, must be frequently replaced. The use of ballasts for converting alternating current to the desired frequency to drive the fluorescent tubes also generates heat, which is undesirable in the refrigerated environment and contributes to inefficiencies by requiring additional cooling to offset the heat generated.

A significant drawback that is addressed in the present disclosure is that the dispersal of light from fluorescent lamps in a display case is frequently inadequate for illuminating all products on the shelves, instead providing significant lighting only to products stocked near the lamps, but not to those stocked across the width of the shelf or to the rear.

However, it remains desirable to improve the efficiency and economy of display case lighting systems and to avoid the drawbacks of fluorescent lighting systems. This can be done, for example, by reducing the amount of energy consumed, by reducing the amount of heat generated unnecessarily by product illumination systems, such as fluorescent lighting, particularly in refrigerated display cases, and by increasing the dispersal of light within the display case. Each of these objectives can be attained by providing a lighting system that uses light emitting diodes in conjunction with a reflector system and which mounts easily to the frame of the display case as disclosed herein.

### SUMMARY OF THE PREFERRED EMBODIMENTS

A lighting system for a commercial display case is disclosed. The display case includes a plurality of mullions disposed in a vertical orientation between adjacent doors of the display case. A plurality of light emitting diodes are disposed in a linear array on the mullions. A reflector system is mounted proximate to the linear array of light emitting diodes to direct the light toward the display shelves. The reflector system preferably includes a series of reflective surfaces disposed in a pattern about the light emitting diodes.

### BRIEF DESCRIPTION OF THE DRAWINGS

The invention may be more readily understood by referring to the accompanying drawings in which:

FIG. 1 is a front perspective view of a refrigerated display case;

FIG. 2 is a top plan view of a portion of the refrigerated display case of FIG. 1 illustrating the configuration of shelves and lighting sources within the display case;

FIGS. 3A-3C are perspective views of alternative embodiments of an LED lighting source with reflectors used in the refrigerated display case of FIG. 1;

FIG. 4 is a perspective view of a preferred embodiment of an LED lighting source with reflectors;

FIG. 5 is a plan view showing the embodiment of FIG. 4 mounted on a mullion; and

Like numerals refer to like parts throughout the several views of the drawings.

### DETAILED DESCRIPTION OF THE PREFERRED EMBODIMENTS

This disclosure relates to the use of reflectors in combination with low voltage LED lighting to provide a simple solution that yields improved light dispersal in an illuminated display case system. Although preferred embodiments are described below, it should be understood that various modifications can be accomplished within the parameters of the present invention.

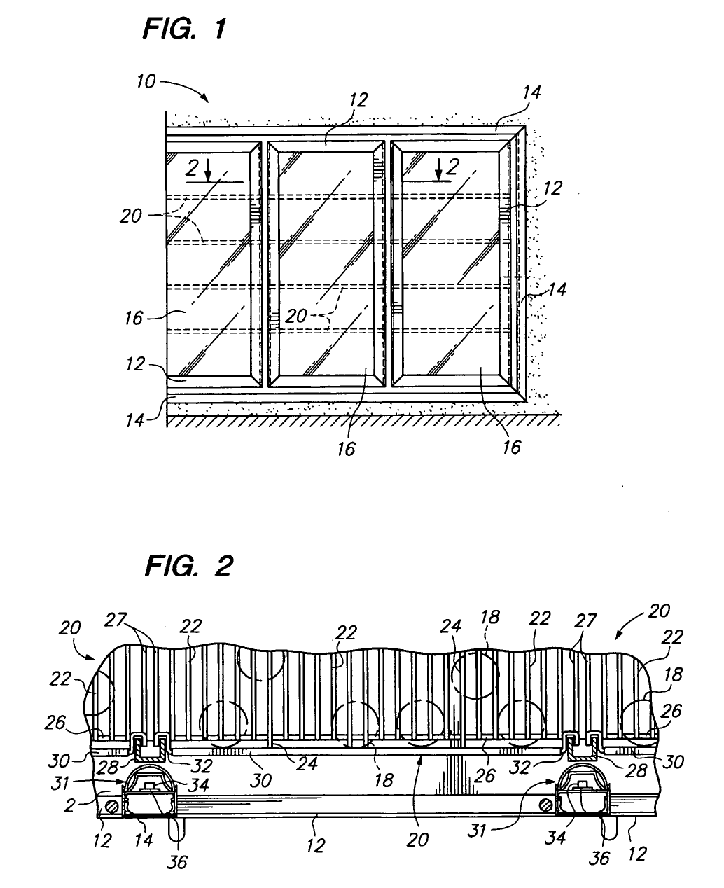

Referring now to FIG. 1, a typical refrigerated display case 10 is illustrated. The display case 10 includes doors 12 mounted in a surrounding frame 14. The doors 12 include glass panels 16 which permit a customer to see items 18 (see FIG. 2) that are displayed inside the case 10 on shelves 20.

FIG. 2 shows a top view of a portion of the display case 10 wherein adjacent shelves 20 are mounted at the same height or level within the case. Each of the shelves 20 is comprised of a plurality of parallel support rods 22, 24, 27 fixed between a front rod 26 and a similar back rod (not shown). The support rods 24 extend a short distance (approximately ½ inch) beyond the front rod 26, and front plates 30 are affixed to the front rod 26 and to the column supports 28 by hook members 32. The support or end rods 27 are mounted in front column supports 28 and in similar back column supports (not shown) which are affixed to the back wall of the display case 10. However, other types of shelf construction may be used for the shelves 20. For example, the shelves 20 may be constructed from sheet metal, may be injection molded, or the like.

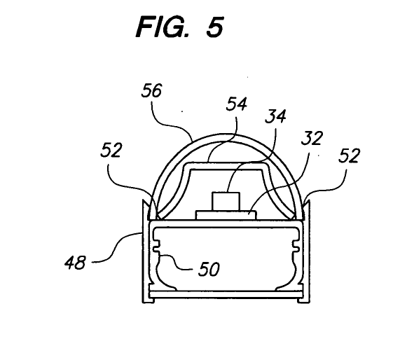

Light sources 31 are affixed by some means to the frame 14 inside the display case 10 in a vertical orientation to provide illumination for items 18 stocked on shelves 20. As shown more clearly in FIG. 5, the frame 14 typically includes a vertical mullion 50 on the inside portion of the frame that runs from top to bottom between each door. Preferably, a mullion cover 48 is coupled to the mullion 50 and includes recesses 52 that permit reflectors 54 and a clear cover 56 to be releasably engaged by the mullion cover. A wide variety of configurations could be contemplated wherein the combination of LED's and reflectors could be mated with the existing vertical mullions.

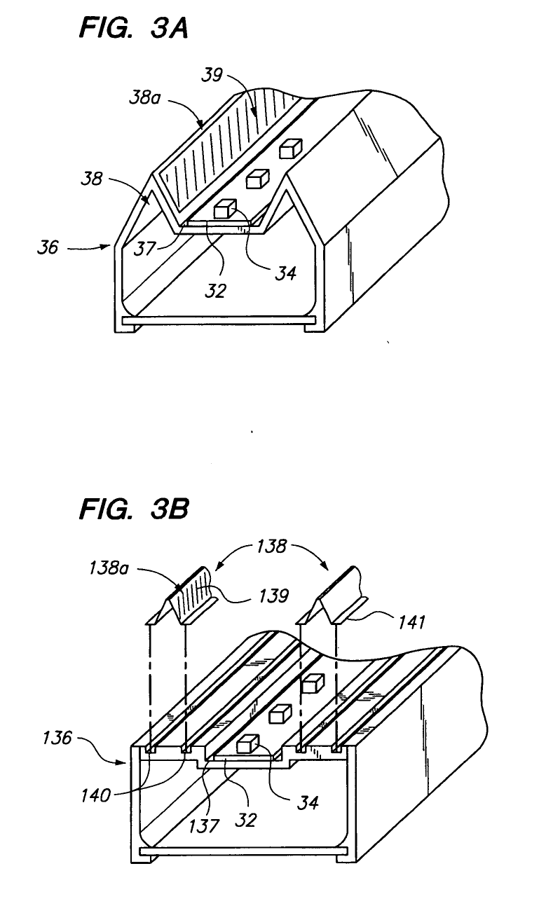

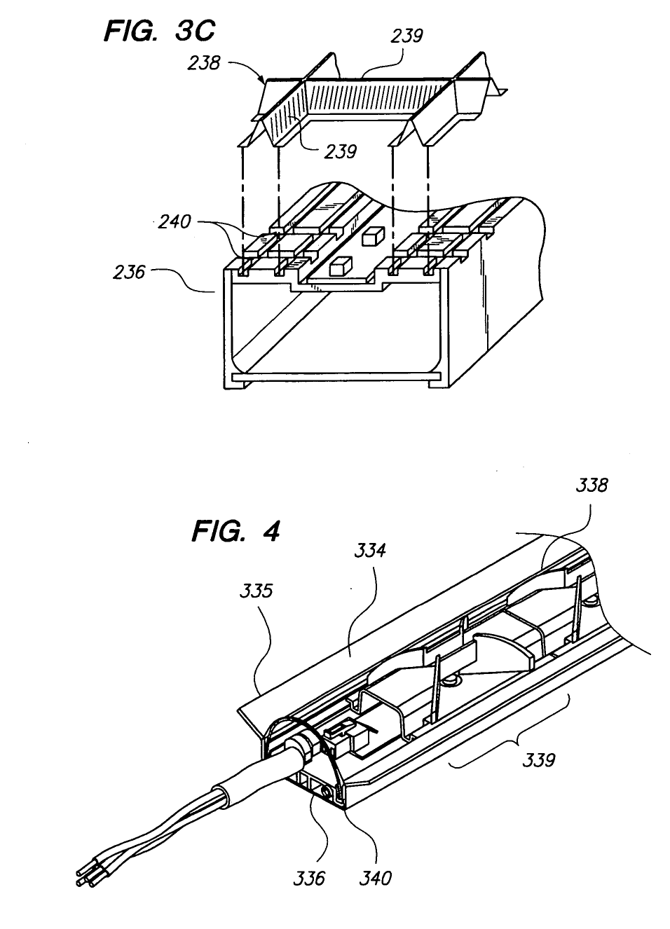

As illustrated in FIG. 3A, a preferred light source 31 includes a length of low-voltage tape 32 having multiple light emitting diodes (“LEDs”) 34 spaced apart in a linear arrangement on the tape and housed within an extruded bracket 36. The low voltage tape 32 may be “LinearLight Flex” as sold by Osram Corporation or similar. The low voltage LEDs 34 may be any suitable commercially available LED, which come in many types and sizes.

Advantageously, the use of LED's as a lighting source provides economical and efficient lighting for commercial display cases. The extruded bracket 36 may be formed as an integral part of the mullion cover 48, or it may be a discrete component that is separately coupled to the mullion cover.

In the embodiment shown in FIG. 3A, the extruded bracket 36 is formed with a central recessed portion 37 and angled side walls 38 rising above the central recess. A reflective coating 39 is added to the inside portion 38a of walls 38. For example, the reflective coating could be an Elamet® coating, which is applied by sprayer or brush to the inside portions 38a of side walls 38.

As an alternative, reflective tape, such as 3M reflective tape, could be adhered to the inside portion 38a. The reflective coating 39 causes the angle of light emitted to be increased and dispersed so as to better illuminate the contents of the display case.

An alternative embodiment is shown in FIG. 3B, wherein the extruded bracket 136 includes a pair of short recesses 140 on either side of the main recess 137. The recesses 140 allow reflector portions 138 to be snapped into place on the bracket 136 and held for example, by tabs 141. A reflective coating 139 is formed on the inside wall 138a of each reflector 138.

It should be clear that a number of different configurations of brackets and reflectors could be described without departing from the scope of the invention. Thus, the brackets and reflectors could be formed as separate components, or as a single integral assembly. Further, whether separate or integral, these parts may be formed from any suitable material, including extruded plastic, sheet metal, or the like.

Another alternative embodiment is shown in FIG. 3C. Here, as in FIG. 3B, the extruded bracket 236 includes a series of short recesses 240 formed along both the length and width of the bracket. A reflector grid 238 is snapped into place in the recesses 240. Reflective coatings 239 are formed on all inside walls 238a to maximize light dispersal across the display shelf. It should be recognized that the configuration, including the size and shape, of a particular grid and reflector system can be determined empirically, or by using mathematical models with appropriate optical data and properties.

The preferred embodiment is shown in FIG. 4. The extruded bracket 336 includes extended surfaces or wings 335 that may be provided with a reflective coating 334. On each side of the bracket 336, recesses 340 are provided such that a reflector system 338 and clear cover 342 can snap into and be held firmly in place. The bracket 336 is preferably formed to mate directly with the mullion 50.

As can be seen, the design of the reflector system 338 is symmetrical about the lighting strip when viewed from the top, and each portion 339 of the reflector system is centered about a single LED. Many different patterns or grids could be contemplated for different cases or different lighting requirements. Mathematical formulas could be derived based on the dimensions of the display case and the optical properties of the selected light emitting diodes to model an illumination system to maximize or optimize lighting dispersal within the display case. For example, different types of surfaces and angles could be employed as necessary for a particular application.

In general, however, the advantage of using LED light sources can be enhanced by providing an application-specific reflector system designed to maximize illumination across the entire display area of a display case.

1. A lighting system for a commercial display case having vertical mullions positioned between doors of the display case, comprising:
a plurality of light emitting diodes disposed in a linear array on the mullion; and
at least one reflector mounted proximate to the light emitting diodes.

2. The lighting system of claim 1, wherein the reflector is made from sheet metal.

3. The lighting system of claim 1, wherein the reflector is made from extruded plastic and covered with a reflective coating.

4. The lighting system of claim 1, wherein the reflector is made from extruded plastic and covered with reflecting tape.

5. The lighting system of claim 1, further comprising a plurality of mullion covers each coupled to one of the mullions.

6. The lighting system of claim 5, wherein the mullion cover and reflector are formed as an integral part.

7. The lighting system of claim 5, wherein the mullion cover and reflector are formed as separate parts and then coupled together.

8. The lighting system of claim 7, wherein the mullion cover includes recesses in an area adjacent to the linear array, and wherein the reflector is coupled to the recesses.

9. The lighting system of claim 1, wherein the reflector comprises a series of reflective surfaces disposed in a pattern about the light emitting diodes.

10. The lighting system of claim 9, wherein the pattern is symmetrical about the light emitting diodes.

11. The lighting system of claim 9, wherein the pattern includes a plurality of portions each being symmetrical about a single light emitting diode.

12. The lighting system of claim 9, wherein the pattern is designed to maximize light dispersal inside the display case.

13. The lighting system of claim 9, wherein the pattern is designed to optimize light dispersal within the display case.

14. A lighting system for a commercial display case having a plurality of mullions oriented vertically between doors of the display case, comprising:
a plurality of light emitting diodes disposed in a linear array on the mullions; and
a plurality of reflectors, each reflector mounted proximate adjacent to the light emitting diodes.

15. The lighting system of claim 14, wherein the reflectors are made from sheet metal.

16. The lighting system of claim 14, wherein the reflectors are made from extruded plastic and covered with a reflective coating.

17. The lighting system of claim 13, wherein the reflectors are made from extruded plastic and covered with reflecting tape.

18. The lighting system of claim 14, further comprising a plurality of mullion covers each coupled to one of the mullions.

19. The lighting system of claim 18, wherein the mullion covers and reflectors are formed as an integral part.

20. The lighting system of claim 18, wherein the mullion covers and reflectors are formed as separate parts and then coupled together.

20. The lighting system of claim 18, wherein the mullions covers include recesses in an area adjacent to the linear array, and wherein the reflectors are coupled to the recesses.

21. The lighting system of claim 18, wherein the mullion covers include recesses in an area adjacent to the linear array, and wherein the reflectors are coupled to the recesses.

22. The lighting system of claim 14, wherein the reflectors are formed as a series of reflective surfaces disposed in a pattern about the light emitting diodes.

23. The lighting system of claim 22, wherein the pattern is symmetrical about the light emitting diodes.

24. The lighting system of claim 22, wherein the pattern includes a plurality of portions each being symmetrical about a single light emitting diode.

25. The lighting system of claim 22, wherein the pattern is designed to maximize light dispersal inside the display case.

26. The lighting system of claim 22, wherein the pattern is designed to optimize light dispersal within the display case.

27. A method for providing lighting in a commercial display case having a plurality of mullions in a vertical orientation between doors of the display case, comprising:
disposing a plurality of light emitting diodes in a linear array on each of the mullions;
mounting at least one reflector proximate to the light emitting diodes.

28. The method of claim 27, wherein the mullion includes mounting features that permit a reflector to be mounted to the bracket.

29. The method of claim 28, wherein the mounting features are disposed on the mullion so as to permit a reflector grid to be mounted to the bracket.

30. The method of claim 28, wherein the mounting features are disposed on the mullion so as to permit a series of reflective surfaces to be mounted to the bracket.

31. The method of claim 27, wherein the reflector comprises a series of reflective surfaces disposed in a pattern about the light emitting diodes.

32. A method for providing lighting in a commercial display case, comprising:
providing a plurality of light emitting diodes vertically disposed in a linear array; and
providing a plurality of reflective surfaces disposed in a pattern about the light emitting diodes.

33. A lighting system for a commercial display case, comprising:
a plurality of light emitting diodes vertically disposed in a linear array; and
a plurality of reflective surfaces disposed in a pattern about the light emitting diodes.

34. The lighting system of claim 33, wherein the pattern is symmetrical about the light emitting diodes.

35. The lighting system of claim 33, wherein the pattern includes a plurality of portions each being symmetrical about a single light emitting diode.

36. The lighting system of claim 33, wherein the pattern is designed to maximize light dispersal inside the display case.

37. The lighting system of claim 33, wherein the pattern is designed to optimize light dispersal within the display case.
